(19) United States
(12) Patent Application Publication
(10) Pub. No.: US 2017/0045966 A1
(43) Pub. Date: Feb. 16, 2017

(54) TOUCH SCREEN PANEL

(71) Applicant: Samsung Display Co., Ltd., Yongin-si (KR)

(72) Inventor: Min Su AN, Yongin-si (KR)

(21) Appl. No.: 15/013,614

(22) Filed: Feb. 2, 2016

(30) Foreign Application Priority Data
Aug. 13, 2015 (KR) 10-2015-0114730

(51) Int. Cl. G06F 3/044

(52) U.S. Cl. CPC G06F 3/044

(57) ABSTRACT

A touch screen panel including a substrate having a touch active area including a plurality of rough areas; a plurality of first sensing electrodes formed on the substrate and corresponding to the plurality of rough areas; a plurality of second sensing electrodes formed on the substrate, at least two of the plurality of second sensing electrodes being disposed in each of the rough areas; and a touch controller configured to determine the rough area where a touch input is detected by driving the first sensing electrodes and to calculate a touch position by driving the second sensing electrodes positioned within the rough area where the touch input is detected.

### CROSS-REFERENCE TO RELATED APPLICATION

This application claims priority from and the benefit of Korean Patent Application No. 10-2015-0114730, filed on Aug. 13, 2015, which is hereby incorporated by reference for all purposes as if fully set forth herein.

### BACKGROUND

Field

Exemplary embodiments relate to a touch screen panel. More particularly, exemplary embodiments relate to a touch screen panel that can reduce power consumption.

Discussion of the Background

A touch screen panel is an input device for inputting a user's command by selecting instructions shown on a screen of an image display device with the user's hand or an object. Since such touch screen panels can replace additional input devices, such as a keyboard and a mouse, that are connected to the image display device in order to operate, touch screen panels have been gaining more popularity.

A resistive type, a photo-sensitive type, and a capacitive type are well-known schemes for implementing a touch screen panel. Among them, the capacitive type includes a self-capacitance type and a mutual capacitance type. The self-capacitance type has advantages of easily implementing a hovering operation and multiple touches.

In such a self-capacitance type of touch screen panel, a plurality of conductive sensing electrodes separated from each other are formed at one surface of the substrate, and each of the plurality of sensing electrodes corresponds to unique position information. In addition, when a user's hand or an object contacts the sensing electrode, a contact position is calculated by detecting a change in capacitance of the sensing electrode. However, in a conventional self-capacitance type of touch screen panel, continuous driving of all sensing electrodes may lead to high power consumption.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention provide a touch screen panel having rough areas in a touch active area of a substrate to detect a touch input position.

Additional aspects will be set forth in the detailed description which follows, and, in part, will be apparent from the disclosure, or may be learned by practice of the inventive concept.

An exemplary embodiment of the present invention discloses: a substrate having a touch active area including a plurality of rough areas; a plurality of first sensing electrodes formed on the substrate and corresponding to the plurality of rough areas; a plurality of second sensing electrodes formed on the substrate, at least two of the plurality of second sensing electrodes being disposed in each of the rough areas; and a touch controller configured to determine the rough area where a touch input is detected by driving the first sensing electrodes and to calculate a touch position by driving the second sensing electrodes positioned within the rough area where the touch input is detected.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1A is a schematic diagram of a touch screen panel according to an exemplary embodiment of the present invention.

FIG. 1B is a cross-sectional view of the touch screen panel illustrated in FIG. 1A along the line I-I′.

FIG. 2A is a schematic diagram of a touch screen panel according to another exemplary embodiment of the present invention.

FIG. 2B is a cross-sectional view of the touch screen panel illustrated in FIG. 2A, and FIG. 2C is a cross-sectional view of a touch screen panel according to a further exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. The regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

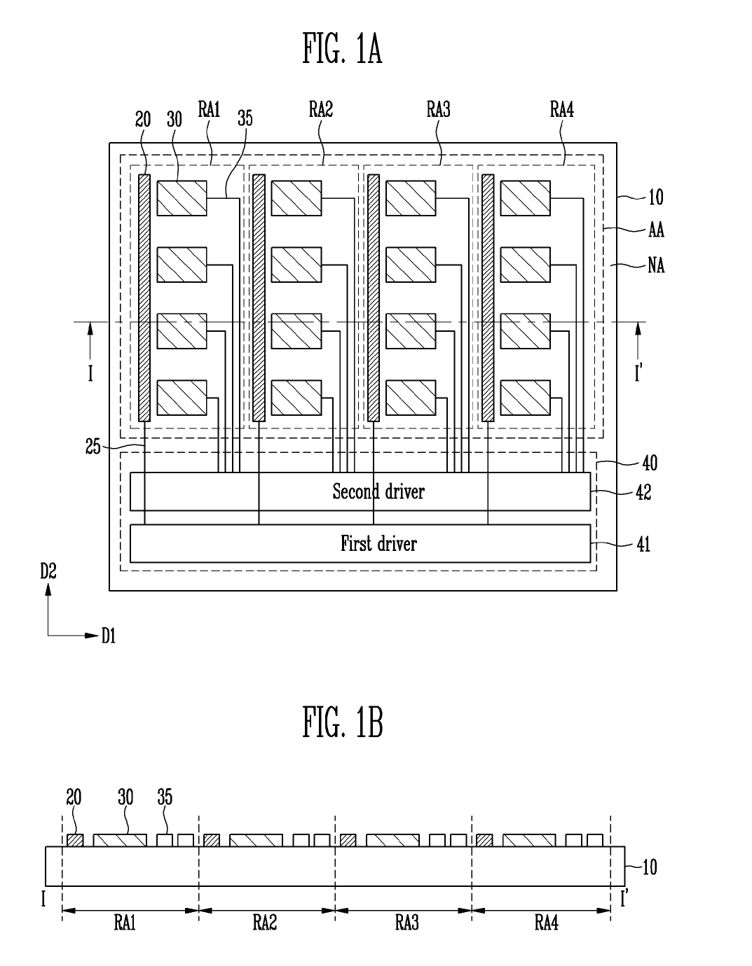

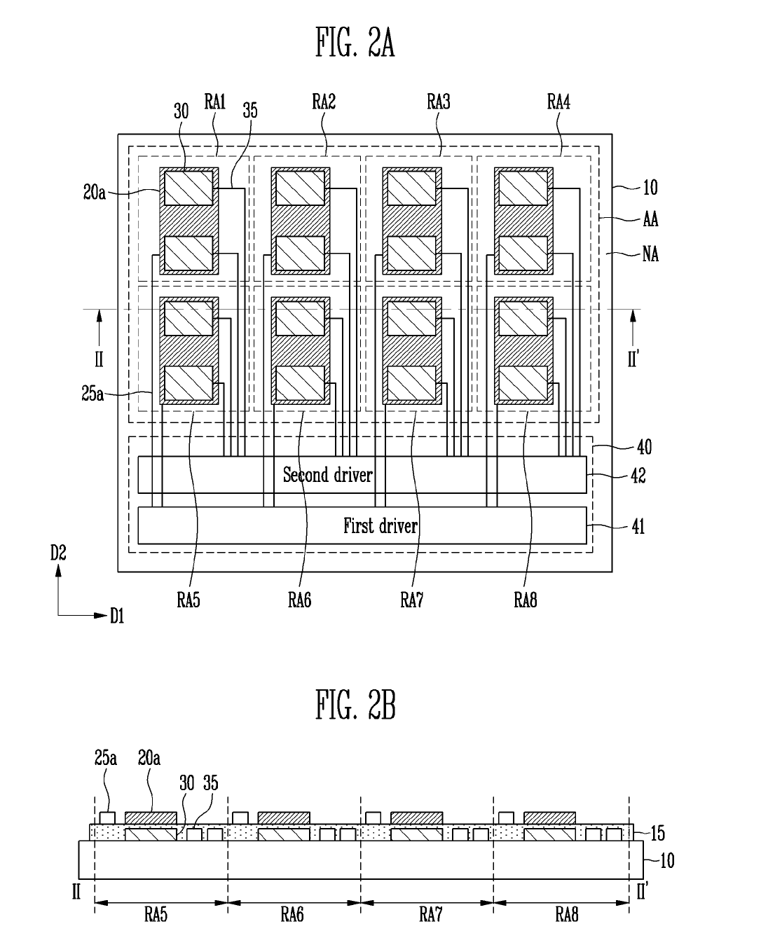

FIG. 1A is a schematic diagram of a touch screen panel according to an exemplary embodiment of the present invention, and FIG. 1B is a cross-sectional view of the touch screen panel illustrated in FIG. 1A.

Referring to FIGS. 1A and 1B, the touch screen panel according to an exemplary embodiment of the present invention includes a substrate 10, first sensing electrodes 20, second sensing electrodes 30, and a touch controller 40.

The substrate 10 may be made of a material that is transparent and has high heat resistance and chemical resistance, and in some exemplary embodiments, may have a flexible characteristic. For example, the substrate 10 may be a thin film substrate that is made of at least one material selected from a group of polyethylene terephthalate (PET), polycarbonate (PC), acryl, polymethyl methacrylate (PMMA), triacetyl cellulose (TAC), polyether sulfone (PES), and polyimide (PI). In addition, the substrate 10 may be made of glass or tempered glass that is generally used. Further, the substrate 10 may be an encapsulation substrate of an organic light emitting diode (OLED) display, or an optical member, e.g., a polarizing film.

The substrate 10 may be divided into a touch active area AA, in which a touch input is enabled, and a touch non-active area NA outside the touch active area AA. In an exemplary embodiment, in the touch screen panel integrated with a display, the touch active area AA overlaps an image display area of a display panel (not shown) to be combined with a touch screen panel and is seen from the outside, while the touch non-active area NA overlaps a non-display area and is not seen from the outside by a frame covering the non-display area or a light blocking layer for blocking light.

The touch active area AA includes a plurality of rough areas RA1 to RA4. The rough areas RA1 to RA4 are smaller than the touch active area AA, and larger than the second sensing electrodes 30, and the touch active area AA may be divided into at least two rough areas. In an exemplary embodiment, four rectangular-shaped rough areas RA1 to RA4 dividing the touch active area AA are illustrated, but the present invention is not limited thereto, and the number, size, and shape of the rough areas RA1 to RA4 may be variously modified.

The first sensing electrodes 20 are a plurality of conductive patterns that are formed on the substrate 10, corresponding to the rough areas RA1 to RA4. Each of the first sensing electrodes 20 is disposed in each of the corresponding rough areas RA1 to RA4, and the number of the rough areas RA1 to RA4 is the same as the number of the first sensing electrodes 20. For example, four of the first sensing electrodes 20 may be arranged in a first direction D1, as are the rough areas RA1 to RA4, such that they are extended in a second direction D2 crossing the first direction D1. In addition, the first sensing electrodes 20 may be made of a transparent conductive material, such as indium tin oxide (ITO), antimony tin oxide (ATO), indium zinc oxide (IZO), carbon nano-tube (CNT), graphene, etc., and may be formed as a mesh type of metal mesh pattern.

The first sensing electrodes 20 are respectively connected to the corresponding first electrode wires 25 and are electrically coupled to the touch controller 40. The first electrode wires 25 may be made of the same material as the first sensing electrodes 20 on the same layer, or may be made of a different material therefrom on a different layer. For example, the first electrode wires 25 may be made of at least one material selected from a group of a transparent conductive material, such as ITO, or a low resistance metallic material such as, for example, molybdenum (Mo), silver (Ag), titanium (Ti), copper(Cu), aluminum (Al), etc.

The second sensing electrodes 30 are formed on the substrate 10, and are a plurality of conductive patterns for sensing a touch input. The second sensing electrodes 30 are uniformly distributed in the touch active area AA such that two or more of the second sensing electrodes 30 are disposed in each of the rough areas RA1 to RA4. Accordingly, the number of the second sensing electrodes 30 is greater than the number of the first sensing electrodes 20. For example, when four of the second sensing electrodes 30 are disposed in each of the rough areas RA1 to RA4, the number of the first sensing electrodes 20 is also four, since it is the same as the number of the rough areas RA1 to RA4, and the number of the second sensing electrodes 30 is sixteen.

In the current exemplary embodiment, the first sensing electrodes 20 and the second sensing electrodes 30 are disposed on the same layer. The first sensing electrodes 20 and the second sensing electrodes 30 may be disposed together within the rough areas RA1 to RA4. The rough areas RA1 to RA4 may be respectively divided in accordance with a row or column unit of the second sensing electrodes 30. For example, one of the first sensing electrodes 20 and a first column of the second sensing electrodes 30 may be disposed within the first rough area RA1.

In an exemplary embodiment, the second sensing electrodes 30 are illustrated to have a quadrangular pattern, but the present invention is not limited thereto, and the second sensing electrodes 30 may be implemented to have various other shapes, including a polygonal shape such as a rhombus, triangular, or hexagonal shape, a circular shape, an oval shape, and the like. The second sensing electrodes 30 may be made of the same material as the first sensing electrodes 20. For example, the second sensing electrodes 30 may be made of a transparent conductive material, such as indium tin oxide (ITO), antimony tin oxide (ATO), indium zinc oxide (IZO), carbon nano-tube (CNT), graphene, etc., and may be formed as a mesh type of metal mesh pattern.

The second sensing electrodes 30 are respectively connected to the corresponding second electrode wires 35, and are electrically coupled to the touch controller 40. The second electrode wires 35 may be made of the same material as the second sensing electrodes 30 on the same layer, or may be made of a different material therefrom on a different layer. For example, the second electrode wires 35 may be made of at least one material selected from a group of a transparent conductive material, such as ITO, or a low resistance metallic material such as, for example, molybdenum (Mo), silver (Ag), titanium (Ti), copper(Cu), aluminum (Al), etc. Since some of the second electrode wires 35 are positioned in the touch active area AA, line widths of the second electrode wires 35 may preferably be formed to be as narrow as possible such that they are less than about several micrometers to about several tens of micrometers.

The touch controller 40 drives the first sensing electrodes 20 to determine on which of the rough areas RA1 to RA4 a touch input is detected. Subsequently, the touch controller 40 calculates a touch position by driving the second sensing electrodes 30 positioned in the rough area where the touch input is detected. The first sensing electrodes 20 correspond to position information of the rough areas RA1 to RA4, and the second sensing electrodes 30 correspond to position information of specific points at which the touch input is generated.

Specifically, the touch controller 40 may include a first driver 41 for driving the first sensing electrodes 20, and a second driver 42 for driving the second sensing electrodes 30. First, the touch controller 40 operates the first driver 41 while the second driver 42 is turned off Next, the touch controller 40 calculates a touch position by driving the second sensing electrodes 30 corresponding to the rough area where the touch input is detected, while not operating the second sensing electrodes 30 corresponding to the rough area where the touch input is not detected.

For example, the touch controller 40 drives all the first sensing electrodes 20 before the touch input is generated. The first driver 41 generates a first detection signal and provides it to the first sensing electrodes 20, and checks whether an electrical characteristic value of the first detection signal is changed. In this case, the second driver 42 is turned off, and the second sensing electrodes 30 are not driven. If a touch input is detected from the third rough area RA3, the touch controller 40 turns the first driver 41 off and turns the second driver 42 on. In this case, the second driver 42 drives only the second sensing electrodes 30 positioned within the third rough area RA3, and does not drive the rest of the second sensing electrodes 30. The second driver 42 generates a second detection signal and provides it to the second sensing electrodes 30 positioned within the third rough area RA3, and checks whether an electrical characteristic value of the second detection signal is changed. The touch controller 40 may calculate the touch position from the second sensing electrode where a change in capacitance is detected.

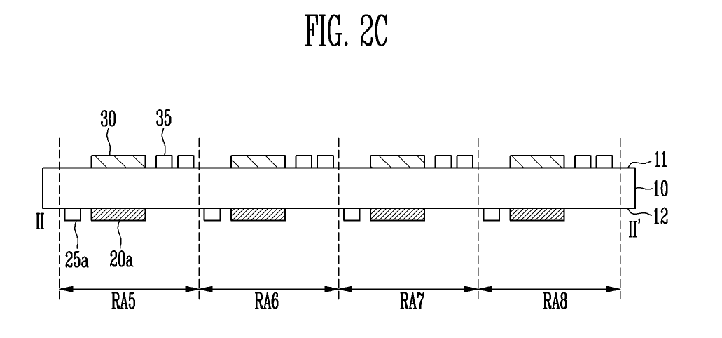

FIG. 2A is a schematic diagram of a touch screen panel according to another exemplary embodiment of the present invention, FIG. 2B is a cross-sectional view of the touch screen panel illustrated in FIG. 2A, and FIG. 2C is a cross-sectional view of a touch screen panel according to a further exemplary embodiment of the present invention.

With respect to the components having the same reference numerals as the above- described components, a duplicate description thereof will be omitted.

Referring to FIGS. 2A and 2B, in the touch screen panel of this exemplary embodiment, first sensing electrodes 20a and second sensing electrodes 30 overlap each other while being disposed on different layers. For this purpose, an insulating layer 15 may be formed between the first sensing electrodes 20a and the second sensing electrodes 30 so as to provide insulation therebetwen.

Specifically, the second sensing electrodes 30 and second electrode wires 35 are formed on a substrate 10. The second sensing electrodes 30 and the second electrode wires 35 may be disposed on the same layer. The insulating layer 15 is formed on the second sensing electrodes 30 and the second electrode wires 35 so as to cover them. In addition, the first sensing electrodes 20a and first electrode wires 25a corresponding to rough areas RA1 to RA8 are formed on the insulating layer 15. In this case, the first sensing electrodes 20a may substantially have the same size and shape as those of the rough areas RA1 to RA8. The first sensing electrodes 20a and the first electrode wires 25a may be disposed on the same layer.

Compared with the previously-described exemplary embodiment, the touch screen panel of the present exemplary embodiment has advantages in that the touch active area

AA can be sufficiently wide, and touch input accuracy can be improved even though a thickness of the touch screen panel increases.

Referring to FIG. 2C, in the touch screen panel according to another exemplary embodiment of the present invention, first sensing electrodes 20a are formed at one surface 12 of the substrate, while second sensing electrodes 30 are formed at the other surface 11 thereof opposite the one surface 12. In the touch screen panel of this exemplary embodiment, a thickness of the touch screen panel can be reduced since an insulating layer 15 for insulating the first sensing electrodes 20a from the second sensing electrodes 30 is not required.

According to the present invention as described above, overall power consumption can be reduced by driving the first sensing electrodes corresponding to the rough areas to determine the rough area where the touch input is detected, and then driving the second sensing electrodes positioned within the rough area where the touch input is detected to calculate the touch position. In addition, because the rest of the second sensing electrodes are not driven if they do not correspond to the rough area where the touch input is detected, noise associated with the touch driving can be reduced.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch screen panel comprising:
a substrate comprising a touch active area, the touch active area comprising a plurality of rough areas;
a plurality of first sensing electrodes disposed on the substrate and corresponding to the plurality of rough areas;
a plurality of second sensing electrodes disposed on the substrate, the plurality of second sensing electrodes being disposed in each of the rough areas; and
a touch controller configured to determine the rough area where a touch input is detected by driving the first sensing electrodes, and to calculate a touch position by driving the second sensing electrodes positioned within the rough area where the touch input is detected.

2. The touch screen panel of claim 1, wherein the number of the rough areas is the same as that of the first sensing electrodes.

3. The touch screen panel of claim 2, wherein the number of the second sensing electrodes is greater than that of the first sensing electrodes.

4. The touch screen panel of claim 3, wherein the first sensing electrodes and the second sensing electrodes are disposed on the same layer.

5. The touch screen panel of claim 4, wherein the rough areas are respectively divided by a row or column unit of the second sensing electrodes.

6. The touch screen panel of claim 3, wherein the first sensing electrodes and the second sensing electrodes are disposed on different layers.

7. The touch screen panel of claim 6, wherein the first sensing electrodes and the second sensing electrodes overlap each other.

8. The touch screen panel of claim 6, further comprising an insulating layer formed between the first sensing electrodes and the second sensing electrodes.

9. The touch screen panel of claim 6, wherein:
the first sensing electrodes are disposed on a first surface of the substrate; and
the second sensing electrodes are disposed on a second surface of the substrate opposite the first surface.

10. The touch screen panel of claim 1, wherein the touch controller comprises:
a first driver configured to drive the first sensing electrodes; and
a second driver configured to drive the second sensing electrodes.

11. The touch screen panel of claim 10, wherein the first driver and the second driver are configured to be alternately operated with respect to each other.

12. The touch screen panel of claim 11, wherein the second driver is configured to drive a first portion of the second sensing electrodes corresponding to the rough area where the touch input is detected, and not to drive a remaining second portion of the second sensing electrodes.

13. The touch screen panel of claim 1, further comprising:
a plurality of first electrode wires respectively connected to the first sensing electrodes; and
a plurality of second electrode wires respectively connected to the second sensing electrodes.
